(19) United States
(12) Patent Application Publication
(10) Pub. No.: US 2016/0343054 A1
(43) Pub. Date: Nov. 24, 2016

(54) IMAGE ACQUISITION AND FEATURE EXTRACTION APPARATUS, METHOD OF FEATURE EXTRACTION AND FEATURE IDENTIFICATION, AND METHOD FOR CREATING AND PROVIDING ADVERTISEMENT CONTENT

(71) Applicants: Kevin Hwading Chu, Houston, TX (US); Xiran Wang, West Lafayette, IN (US); Wei Song, Houston, TX (US)

(72) Inventors: Kevin Hwading Chu, Houston, TX (US); Xiran Wang, West Lafayette, IN (US); Wei Song, Houston, TX (US)

(73) Assignee: Status Quo Innovation, LLC, Houston, TX (US)

(21) Appl. No.: 14/714,349

(22) Filed: May 18, 2015

(51) Int. Cl. G06Q 30/06; G06F 17/30

(52) U.S. Cl. CPC G06Q 30/0627; G06F 17/30424

(57) ABSTRACT

A system including: a computing device having a display and a memory, the memory is configured to store an image, and a server having a processor and a database. The processor is configured to: receive the image from the computing device, extract a feature from the image, compare an extracted feature of the image to an entry in the database, determine that the extracted feature matches the entry in the database, receive, from a partner server, a product listing associated with the extracted feature, and display the product listing on the display.

### BACKGROUND

Feature extraction and feature identification (i.e., feature detection) are methods used to extract and identify features from an input image.

### SUMMARY

In general, in one aspect, one or more embodiments disclosed herein relate to a system comprising: a computing device having a display and a memory, the memory is configured to store an image; and a server having a processor and a database, wherein the processor is configured to: receive the image from the computing device, extract a feature from the image, compare an extracted feature of the image to an entry in the database, determine that the extracted feature matches the entry in the database, receive, from a partner server, a product listing associated with the extracted feature, and display the product listing on the display.

In another aspect, one or more embodiments disclosed herein relate to a method comprising: receiving an image from a computing device; extracting a feature from the image; comparing an extracted feature to an entry in a database; determining that the extracted feature matches the entry in the database; receiving a product listing associated with the extracted feature; and displaying the product listing on the computing device.

In yet another aspect, one or more embodiments disclosed herein relate to a non-transitory computer readable medium comprising computer readable program code, which when executed by a computer processor, enables the computer processor to: receive an image from a computing device; extract a feature from the image; compare an extracted feature to an entry in a database; determine that the extracted feature matches the entry in the database; store a matched extracted feature in the database; receive a product listing associated with the extracted feature; display the product listing on the computing device; and redirect a user to a partner webpage associated with the product listing or to a partner application associated with the product listing upon determining that the user has interacted with a link of the product listing

Other aspects and advantages of the disclosure will be apparent from the following description and the appended claims.

### BRIEF DESCRIPTION OF DRAWINGS

FIG. 1 shows an image acquisition and feature extraction system according to one or more embodiments of the disclosure.

FIG. 2 shows a server of the image acquisition and feature extraction system according to FIG. 1.

FIG. 3 shows a method of feature extraction and identification according to one or more embodiments of the disclosure.

FIG. 4 shows a screenshot of an application being executed by a computing device of the image acquisition and feature extraction system according to FIG. 1.

FIG. 5A shows a screenshot of an application being executed by a computing device of the image acquisition and feature extraction system according to FIG. 1.

FIG. 5B shows a screenshot of an application being executed by a computing device of the image acquisition and feature extraction system according to FIG. 1.

FIG. 6A shows a screenshot of an application being executed by a computing device of the image acquisition and feature extraction system according to FIG. 1.

FIG. 6B shows a screenshot of an application being executed by a computing device of the image acquisition and feature extraction system according to FIG. 1.

FIG. 6C shows a screenshot of an application being executed by a computing device of the image acquisition and feature extraction system according to FIG. 1.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure relate to an image acquisition and feature extraction apparatus. In general, embodiments of the disclosure relate to a method of feature extraction and feature identification. In general, embodiments of the disclosure relate to a method for creating and providing advertisement content.

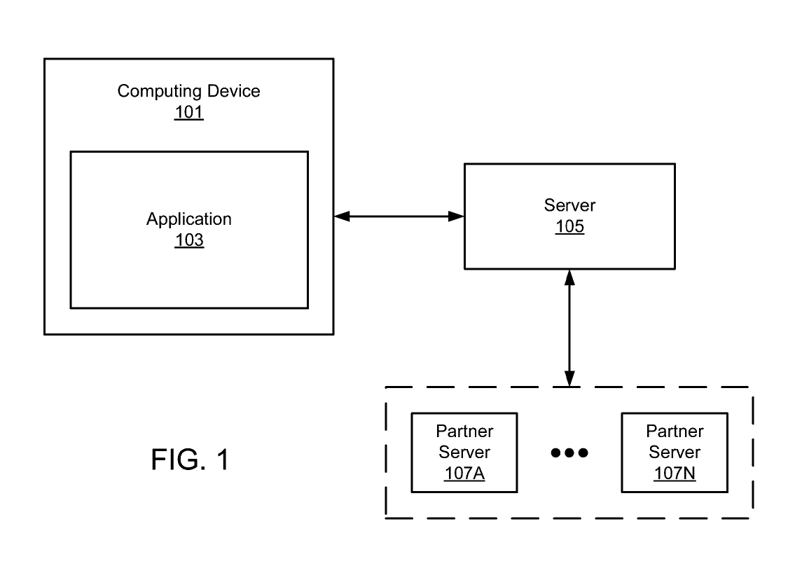

FIG. 1 shows an image acquisition and feature extraction system according to one or more embodiments of the disclosure. As shown in FIG. 1, the system has multiple components including a computing device (101) executing one or more applications (103), a server (105), and one or more partners (107A, 107B).

As also shown in FIG. 1, various components of the system may communicate directly or indirectly with one another. The communication may be exchange of information, storage of information, etc. The information within the system described herein may be stored in one or more data structures. Further, any data structure type (e.g., arrays, linked lists, hash tables, etc.) may be used to organize information within the data structure(s) provided that the data structure type(s) maintain the various exchange of information described. Each of these components is described below.

In one or more embodiments of the disclosure, the computing device (101) may be a desktop personal computer (PC), a laptop, a tablet computer, an electronic reader (e-reader), a cable box, a kiosk, a smart phone, a server, a mainframe, a personal digital assistant (PDA), or any other type of hardware device. The computing device (101) may include a processor, persistent storage, and a memory to execute the one or more applications (103). The computing device (101) may communicate (directly or indirectly) with the server (105) and/or one or more partner servers (107A, 107N) using any wired and/or wireless (e.g., wifi, cellular, etc.) connections.

In one or more embodiments of the disclosure, the computing device (101) may also include one or more input device(s) (not shown), such as a touchscreen, keyboard, mouse, microphone, touchpad, electronic pen, or any other type of input device. Further, the computing device (101) may include one or more output device(s) (not shown), such as a screen (e.g., a liquid crystal display (LCD), a plasma display, touchscreen, cathode ray tube (CRT) monitor, projector, or other display device, a printer, external storage, or any other output device. One or more of the output device(s) may be the same or different from the input device(s). Many different types of computing systems exist, and the aforementioned input and output device(s) may take other forms.

In one or more embodiments of the disclosure, the application (103) may be a software application of any type. For purposes of illustration only, the application (103) is an image processing application going forward. In one or more embodiments of the disclosure, the application may be implemented to include one or more advertisement placements. An advertisement placement is a predefined space in an application used to display one or more native or non-native online advertisements. For example, the advertisement placement may be a specific location within the user interface of an application. In another example, the advertisement placement may be associated with a feature in the application, e.g., in a news feed, a user profile message board, a message feed, or a stream. In one or more embodiments of the disclosure, the stream is a presentation of, list of, or other organization of content within application (103). The stream may include both content and ads (which may include native ads). Further, one of ordinary skill in the art would appreciate that the advertisement placement is not limited to being placed in an application, but may be applicable to a webpage, etc.

In one or more embodiments of the disclosure, the server (105) may be implemented on hardware device that includes a memory and a processor. The server (105) is operatively connected to the application (103) and/or one or more partners (107A, 107N). In one or more embodiments of the disclosure, the server (105) may communicate (directly or indirectly) with the computing device (101) and/or one or more partner servers (107A, 107N) using any wired and/or wireless (e.g., wifi, cellular, etc.) connections. In one or more embodiments of the disclosure, the server (105) may be associated with the application (103). That is, the two may belong to the same entity.

In one or more embodiments of the disclosure, the one or more partner servers (107A, 107N) may be associated with an advertisement provider, a product/service provider, a 3^{rd} party entity, etc. The one or more partner servers (107A, 107N) is operatively connected to the computing device (101), the application (103) and/or the server (105). In one or more embodiments of the disclosure, the one or more partner servers (107A, 107N) may provide an advertisement content, a product listing, a recommend product listing, a trademark product listing, etc.

In one or more embodiments of the disclosure, the advertisement content may come in any size, form, content, etc. In one or more embodiments of the disclosure, the product listing is compiled by the matching module (207) and has a listing of an extracted feature's price, location of the merchant selling the extracted feature, etc. In one or more embodiments of the disclosure, the recommended product listing may be similar in display to that of the product listing. However, the recommended product listing is different from the product listing at least in that it is computed and compiled based on a user using the application (103). In one or more embodiments of the disclosure, the trademark product listing is similar in display to that of the product listing and the recommended product listing. However, the trademark product listing is different from the product listing and the recommended product listing in that the trademark product listing obtains and displays one or more product listings associated with a particular trademark.

Those skilled in the art will appreciate that while FIG. 1 shows a particular system configuration, the disclosure is not limited to the aforementioned system configuration.

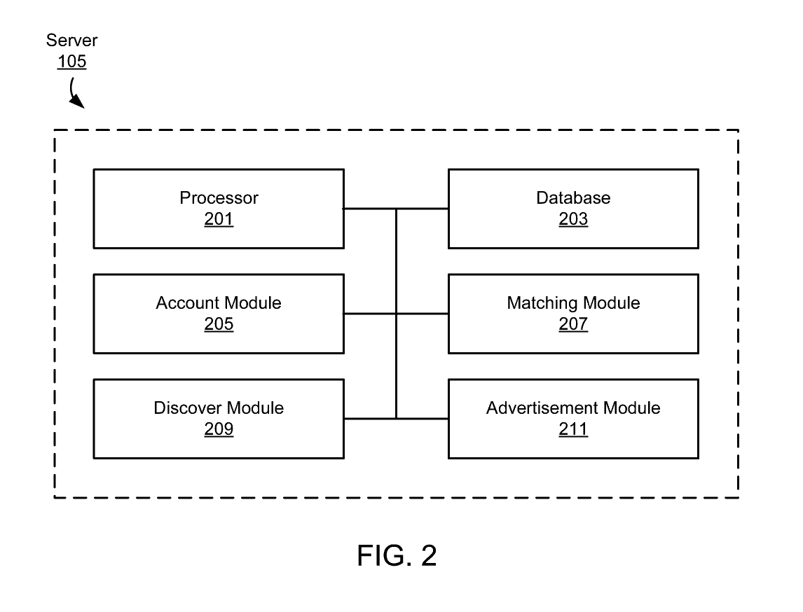

FIG. 2 shows a server of the image acquisition and feature extraction system according to FIG. 1. In one or more embodiments of the disclosure, the server may comprise multiple components including a processor (201), a database (203), an account module (205), a matching module (207), a discover module (209), and an advertisement module (211). Each of these components is described below.

In one or more embodiments of the disclosure, the processor (201) may be an integrated circuit for processing instructions. For example, the processor (201) may be one or more cores, or micro-cores of a processor.

In one or more embodiments of the disclosure, the database (203) is configured to store product listings, trademark product listings, product reviews, recommended product listings, advertisement contents, etc. These various contents may be retrieved/updated from the one or more partner servers (107A, 107N) either in real-time or in batches at a predetermined amount of time.

In one or more embodiments of the disclosure, the database (203) is configured to receive size information from a user. That is, the user may input his or her shoe size, hat size, waist size, inseam, etc.

In one or more embodiments of the disclosure, the various product listings of the database (203) may comprise a purchasing price for a hat. For example, if a hat has been extracted by the matching module (207), the server (105) may display to the user using the computing device (101) a plurality of options to purchase hats (being listed in order of, say, price). The price of a hat being listed in one person's application (103) need not be the same as the price of the same hat being listed in another person's application (103). Using matched extracted feature information, location of the user (e.g., zip code, etc.), purchasing behavior of the user, purchasing history of the user, as well as any information to be provided by the one or more partner servers (107A, 107N), the server (105) may adjust prices accordingly. In one or more embodiments of the disclosure, the prices may be adjusted such that they are below a retail price but above an original purchase price to be assigned to the user. The original purchase price is the price that would have been assigned to the user had the system not been able to obtain the various user information described above. The retail price is what one would have to pay at stores nearby the user. In one or more embodiments of the disclosure, the prices may also be adjusted such that they are below both the retail price and the original purchase price to provide added incentive to get the user to buy the product. One of ordinary skill in the art would appreciate that such a dynamic pricing model need not be applied to clothing, but that it can also be applied to any product and/or service.

In one or more embodiments of the disclosure, the account module (205) is configured to store information of one or more users. The information may comprise size information, browsing information, fashion information, etc., tailored to each of the one or more users. The information may help the discover module (209) and the advertisement module (211) display, to the one or more users, more accurate advertisement content. The information may be edited andlor displayed in the application (103).

In one or more embodiments of the disclosure, the matching module (207) may be configured to receive an image from the computing device (101), extract and identify features in the image, and compare the extracted and identified features of the image to entries in the database (203). In one or more embodiments of the disclosure, the matching module (207) may further extract an imaged person's size information (e.g., shoe size, inseam, waist size, etc.).

In one or more embodiments of the disclosure, if there is a match between the feature and the entry, the match and its relevant information (e.g., timestamp for match, etc.) may also be stored in the database (203) and be used as basis for the discover module (209) and the advertisement module (211) to create content (i.e., advertisement, recommended product listing, etc.).

In one or more embodiments of the disclosure, the discover module (209) uses at least one of a location of the computing device (101), the size information, trending information, a friend listing, and the matched extracted feature to generate a recommended product listing and display the recommended product listing in the application (103).

In one or more embodiments of the disclosure, the application (103) may, using the discover module (209), compile and display a friend listing. That is, the application (103) may determine that a friend has recently extracted certain features, e.g., a pair of blue jeans and a cowboy hat. Depending on the setting of the friend, the user using the application (103) may be able to observe the product listing (i.e., friend listing) comprising the pair of blue jeans and the cowboy hat. As discussed above, this particular feature advantageously enables friends to share what they are interested in and determine where certain articles may be purchased and at what prices.

In one or more embodiments of the disclosure, the advertisement module (211) uses at least one of a location of the computing device (101), the size information, trending information, and the matched extracted feature to generate a relevant advertisement. For example, the advertisement module, upon detecting an extracted feature and determining that the extracted feature is a hat, locates a store nearby that sells the hat. The advertisement module, in turn, generates an advertisement content and displays such a content when the user is using the application.

In one or more embodiments of the disclosure, the trending information may simply be a listing of what item is the most popular (i.e., the item being extracted the most by the community of users using the application (103)). In one or more embodiments, the trending information may be manually set by the server (105) for promotional purposes, etc. In one or more embodiments of the disclosure, the trending information may be a popular feature that has been extracted by friends.

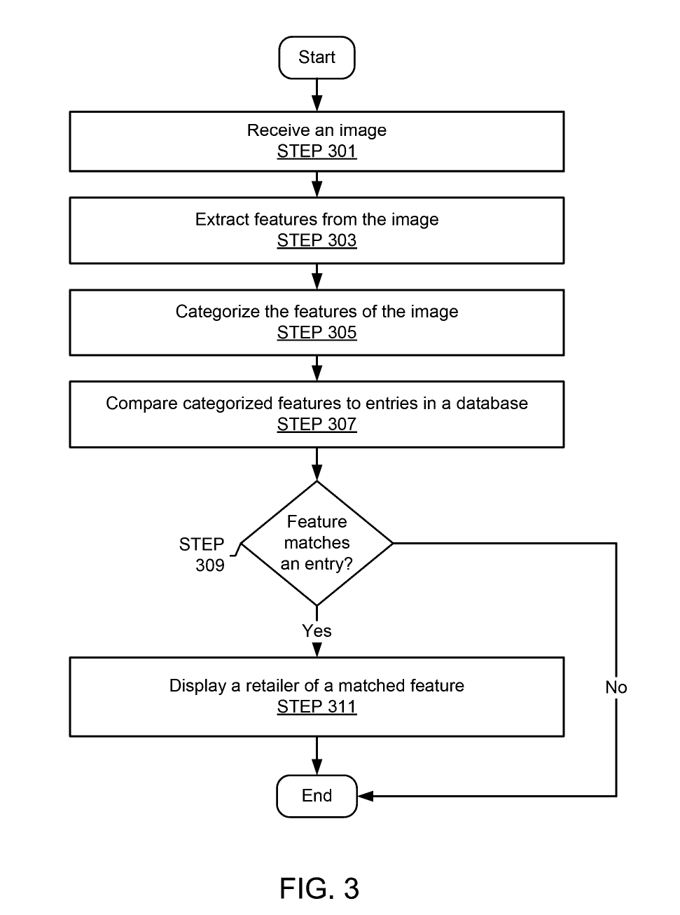

FIG. 3 shows a method of feature extraction and identification according to one or more embodiments of the disclosure. FIG. 3 shows a flowchart. While the various steps in the flowchart is presented and described sequentially, one of ordinary skill will appreciate that some or all of the steps may be executed in different orders, may be combined or omitted, and some or all of the steps may be executed in parallel.

In Step 301, an image is received by a server. The image may be taken by an image acquisition apparatus (e.g., camera, mobile device, etc.).

In Step 303, features are extracted from the image by the server. Techniques that may be used to extract features are numerous and will not all be discussed for the sake of brevity. Feature extractions involve taking a large set of data and reducing the set to a minimum to describe what is needed to be extracted from the data. For purposes of illustration only, features may be, for example, articles of clothing, dresses, accessories, footwear, bottoms, etc. However, one of ordinary skill in the art would appreciate that features may be anything ranging from a logo, trademark, sound wave, products, symbols, etc.

In one or more embodiments, application-dependent features may be predetermined and applied to the application. Alternatively, or in addition to application-dependent features, generic dimensionality reduction techniques may be used to extract features. Some feature extraction techniques include: Principal component analysis (PCA), Kernel PCA, Multilinear PCA, Multifactor dimensionality reduction, Multilinear subspace learning, Nonlinear dimensionality reduction, Isomap, Latent semantic analysis, Partial least squares, Independent component analysis, Autoencoder, etc.

In image processing, some specific feature extraction techniques include: Edge detection, Corner detection, Convolutional neural network, Blob Detection, Ridge detection, Scale-Invariant feature transform, Edge direction, Changing intensity, Autocorrelation, Motion detection, Thresholding, Blob extraction, Template matching, Hough transform, Deformable Thresholding, Active contours, etc.

In cases where templates may be required (e.g., template matching, etc), templates may also be stored in the database (203).

One of ordinary skill in the art would appreciate that the methods described above are not exhaustive and that the techniques may be used alone or in combination with one another.

In Step 305, the extracted features may first be categorized. For example, the processor may first determine that a hat, a scarf, and a pair of shoes have been detected. Once the categories of the detected features have been determined, the matching module (207) may then determine whether the detected features match with the entries in the database (203). In one or more embodiments of the disclosure, the matching module (207) may directly extract features and compare the extracted features to entries in a database without categorizing using Step 305. In one or more embodiments of the disclosure, the categorization may be layered. Specifically, the system may first determine that a feature is an accessory and then search within the accessory category to determine that the accessory is a hat.

In Step 307, the categorized extracted features are each compared to entries in a database. In one or more embodiments of the present disclosure, the categorization may allow for parallel processing so as to process inquiries more efficiently. The categorizing may enable the matching module (207) to simultaneously match a plurality of items of different categories. However, as discussed above, it is also possible for the matching module (207) to directly extract features and compare them to entries in the database (203) one by one.

In Step 309, the matching module (207) determines whether the categorized extracted features/extracted features match with any of the entries in the database (203). If there is no match, the flowchart may end. If there is a match for any categorized extracted feature/extracted feature, the flowchart may proceed to Step 311.

In Step 311, a product listing relevant to the matched categorized extracted feature/matched extracted feature is listed along with information on price, whereabouts the item may be purchased, relevancy in comparison to the extracted feature, etc. In one or more embodiments of the disclosure, relevancy may be a score (i.e., percentage match between the matched product listing and the extracted feature).

In one or more embodiments, the match may be stored as an entry in the database. The match may be subsequently used by, for example, the discover module (209) and the advertisement module (211) to provide content. In one or more embodiments of the disclosure, the match may also be provided to the one or more partner servers (107A, 107N) to demonstrate the effectiveness of the application (103A) in promoting the partner's products.

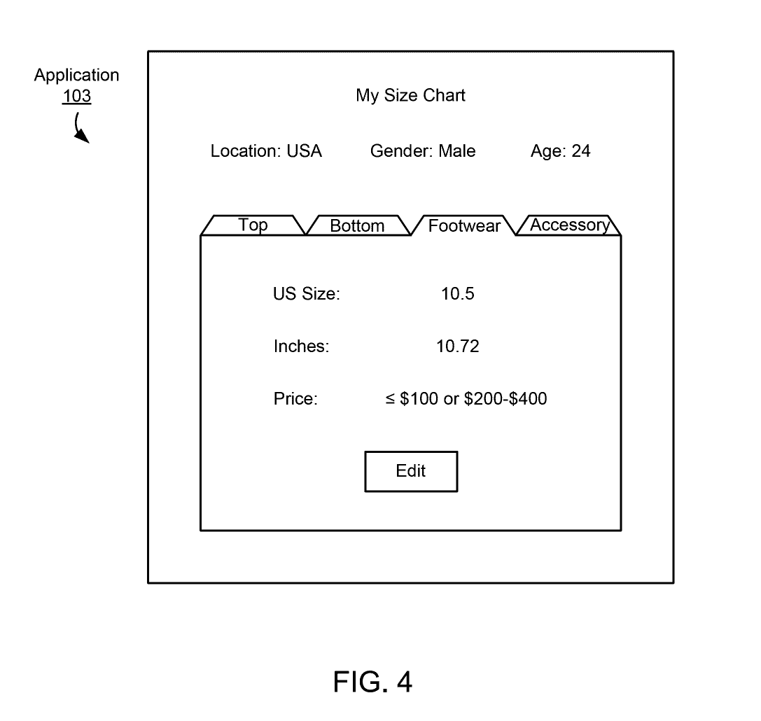

FIG. 4 shows a screenshot of an application (103) being executed by a computing device (101) of the image acquisition and feature extraction system according to FIG. 1.

FIG. 4 shows a size chart for a user using the application (103). The application (103) enables the user to input his various measurements for different articles (e.g., tops, bottoms, footwear, accessories, etc). The tops may, for example, be further divided into subcategories including: long-sleeves, t-shirts, short sleeves, jackets, coats, etc. The bottoms may, for example, be further divided into subcategories including: trousers, shorts, jeans, etc. The footwear may, for example, be further divided into subcategories including: sandals, sneakers, boots, etc. The accessories may, for example, be further divided into subcategories including: scarves, hats, earrings, rings, necklaces, etc.

In the size chart, the user is also provided with the option to limit his budget. This particular setting influences the various product listings he receives from the advertisement module (211), the discovery module (209), etc. The budget may be a general budget for every item. Otherwise, the budget may be set for each particular category/subcategory of items. In one or more embodiments of the disclosure, the user is able to set the budget by specifying what he or she is willing to view as a maximum and/or a minimum price. In one or more embodiments of the disclosure, the user is able to set the budget by specifying a range of what he or she is willing to view.

FIG. 4 specifically indicates that the user is located in the United States (US) (the location may be manually inputted or detected by the computing device (101)), that the user is a male, and that the user is 24 years of age. All of this information may be automatically detected (assuming that there is a source of the information (for example, the application (101) is synchronized with the user's email and happens to scan and detect the user's plane itinerary; the itinerary has the user's age)) or manually input by the user. FIG. 4 specifically indicates that the user wears a US size 10.5 and that his foot is roughly 10.72 inches in length. Finally, FIG. 4 also illustrates that the user budget for any footwear is either less than or equal to $100 or between $200 and $400, inclusive. The budget may limit the footwear that the user receives from the advertisement module (211), the discover module (209), the one or more partner servers (107A, 107N) to those that are less than or equal to $100 or between $200 and $400, inclusive.

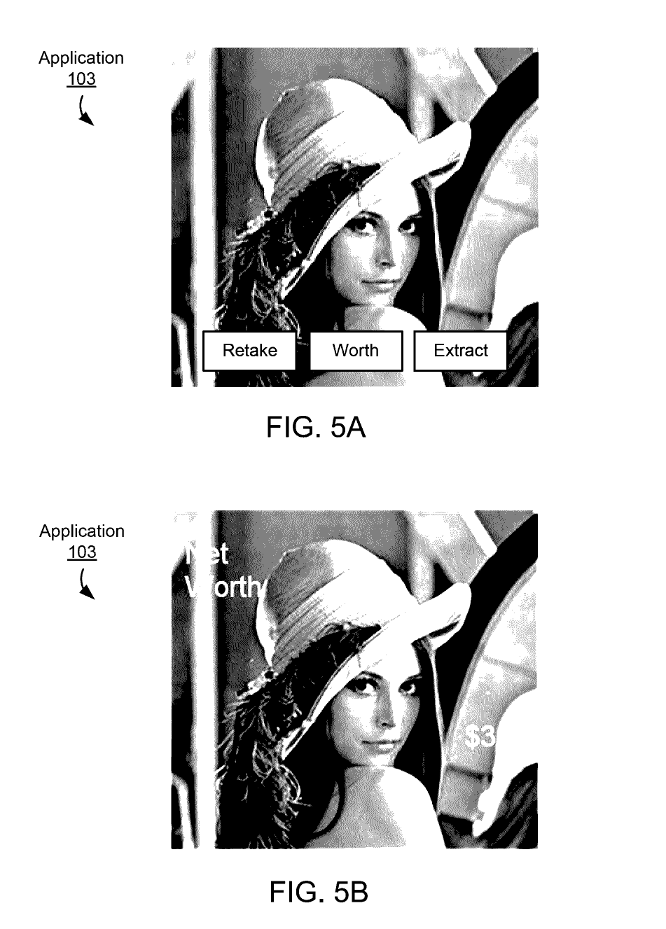

FIG. 5A shows a screenshot of an application being executed by a computing device of the image acquisition and feature extraction system according to FIG. 1.

FIG. 5A shows an image that the server (105) has received via the application (103). The image, as discussed, is not limited and may be a photograph, a caricature, a cartoon, a video stream, etc. The application (103), upon sending the image to the server (105), also prompts the user of the computing device (101) with possible actions. For example, the user is able to retake (retake another photograph) or resubmit an image for processing by interacting with (i.e., clicking on) the “RETAKE” button. For example, the user is able to analyze the worth of the extracted features by interacting with (i.e., clicking on) the “WORTH” button. For example, the user is able to identify what and where certain extracted features can be purchased by interacting with (i.e., clicking on) the “EXTRACT” button. One of ordinary skill in the art would appreciate that other actions are available and that the features of the application (103) are not limited to those described above.

FIG. 5B shows a screenshot of an application being executed by a computing device of the image acquisition and feature extraction system according to FIG. 1.

FIG. 5B may be a screenshot displayed when a user decides to interact with the “WORTH” button in FIG. 5A. Upon detecting that the “WORTH” button has been interacted, the server (105) extracts features in the image, determines that there is a hat, and values the hat. In this example, the server (105) only detects a hat and, in accordance with entries in the database (203), values the hat to be $35. Methods for valuing the hat are various; for instance, the server (105) may simply average the prices associated with the product listings generated by the extracted feature (i.e., the hat). Otherwise, historical purchase data, user purchasing behavior, etc., may be utilized to help determine the net worth of the image.

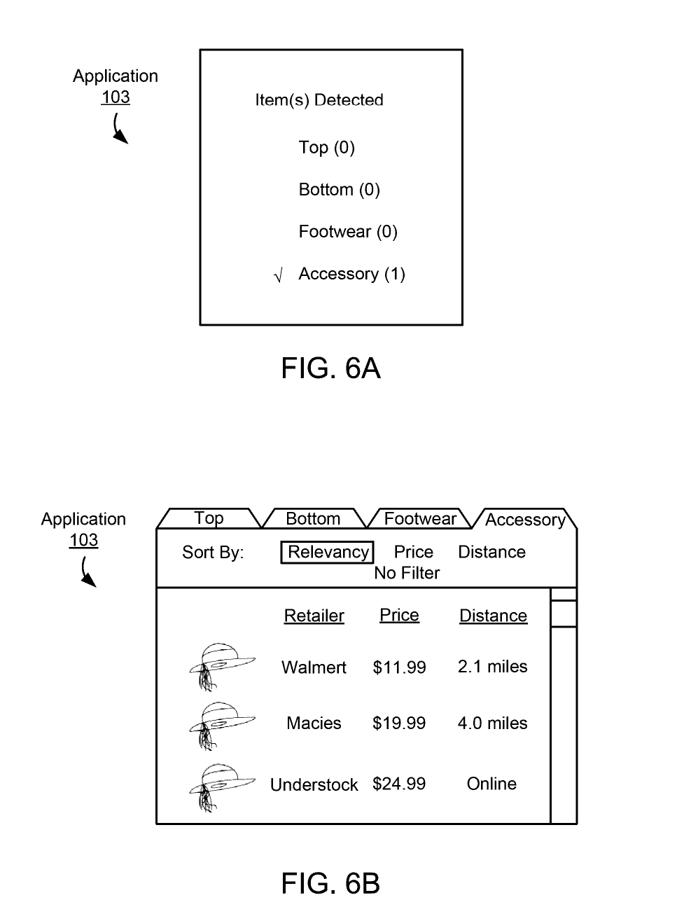

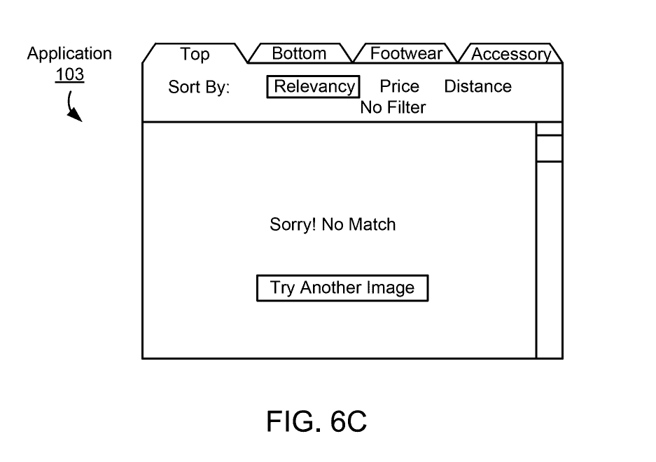

FIG. 6A shows a screenshot of an application being executed by a computing device of the image acquisition and feature extraction system according to FIG. 1.

FIG. 6A may be a screenshot displayed when a user decides to interact with the “EXTRACT” button in FIG. 5A. As discussed above, the server (105) only detects the hat. Because hats are categorized as accessories, FIG. 6A shows the accessory category being marked with a checkmark and a number indicating how many accessories were detected in the image.

FIG. 6B shows a screenshot of an application being executed by a computing device of the image acquisition and feature extraction system according to FIG. 1.

FIG. 6B may be a screenshot displayed when a user decides to interact with the “Accessory (1)” button in FIG. 5A. As discussed above, the server (105) only detects the hat. Because hats are categorized as accessories, FIG. 6A shows the accessory category being marked with a checkmark and a number indicating how many accessories were in the image.

FIG. 6B illustrates that the hat detected in the image may be purchased in Walmert (2.1 miles from the computing device (101)), Macies (4.0 miles from the computing device (101)), and Understock (may be purchased online) for $11.99, $19.99, and $24.99, respectively.

For purposes of illustration only, we assume that the prices are dynamically priced. For example, although the application (103) displays the price of the hat at Walmert to be $11.99, the Walmert store price may actually be $14.99. The user may be able to get the hat for $11.99 at Walmert by interacting with the “Walmert” button in the application (103). Such an interaction may lead to a coupon being displayed in the application (103) that a clerk at Walmert may scan to take $3.00 off from the $14.99 ticket price.

For purposes of illustration only, we again assume that the prices are dynamically priced. Further assume that a hat from Understock is actually priced at $19.99. As a clarification, the hat is not the same hat as the one sold at Walmert and Macies. The next alternative to the Understock hat, for example, is a Saks Fourth Avenue hat priced at $29.99. The Saks Fourth Avenue hat being the same hat as the Understock hat. Based on the user's purchasing behavior, information, etc., the server (105) determines that the user has a favorable probability in purchasing the hat at $24.99. Thus, the server (105) prices the hat $24.99, which is still lower than the $29.99 he or she would have had to pay at Saks Fourth Avenue, but higher than the original price of $19.99 set by Understock.

As shown in FIG. 6B, once the matching module (207), the database (203), and the one or more partner servers (107A, 107N) generate a product listing from the extracted features, the user is able to sort the product listing by relevancy (how similar it is in appearance to the originally extracted feature), price (from the cheapest to the most expensive option, and vice versa), distance (how close/far the item may be purchased). The user may decide to filter out all online items. Alternatively, the user may decide to only receive online product listings. If the user would like to have more product listings, he or she is able to click on the “No Filter” button. This effectively removes, for example, the budget/limitation (i.e., online only) set by the user. In one or more embodiments, the user is able to set a maximum number of returned product listings. For example, if there are over 100 product listings and the user only wants to see a maximum of 50 items listed, the application (103) will only display 50 items. The 50 displayed items are displayed depending on the user's preference (relevancy, price, distance, etc.).

FIG. 6C shows a screenshot of an application being executed by a computing device of the image acquisition and feature extraction system according to FIG. 1.

FIG. 6C illustrates an example of a screenshot by the application (103) when no feature is extracted from the input image. The user is able to interact with the “Try Another Image” to either take another photograph or select another image as input image.

While the disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the disclosure has been described with respect to a limited number of embodiments, those skilled in the art, having benefit of this disclosure, will appreciate that other embodiments can be devised which do not depart from the scope of the disclosure as disclosed herein.

For example, the trending information may be gathered using geofencing.

For example, when a new product related to a matched extracted feature has arrived on the market, the application (103) may alert the user that the new product has arrived.

For example, the user may be able to filter displayed product listings by texture (e.g., material made, place of manufacture, drying machine compatibility, etc.).

For example, based on the user's purchasing behavior, the matched extracted feature, etc., a fashion information showing items that may interest the user may be sent to the user by the discover module (209) using email, text message, etc., or to the user in-app.

For example, after extracting a certain feature from the image, the server (105) may be able to return other items that may go well along with the certain feature.

For example, if a full body image of a user is received, the system may be able to come up with complementary suggestions. For example, if an input is a man in a tuxedo, the output may be formal dress for a woman. The user is, of course, able to adjust the budget to limit what suggestions he or she sees. Of course, depending on user input, the complementary suggestion of a male input may not necessarily be a female output for complementary suggestion. Additionally, this feature may be extended to father-son pairs, etc.

Furthermore, one of ordinary skill in the art would appreciate that certain “components,” “units,” “parts,” “elements,” or “portions” of one or more embodiments of the present disclosure may be implemented by a circuit, processor, etc., using any known methods. Accordingly, the scope of the disclosure should be limited only by the attached claims.

1. A system comprising:
a computing device having a display and a memory, the memory is configured to store an image; and
a server having a processor and a database,
wherein the processor is configured to:
receive the image from the computing device,
extract a feature from the image,
determine and store a user size information for the feature based on the image,
compare an extracted feature of the image to an entry in the database,
determine that the extracted feature matches the entry in the database,
receive, from a partner server, a product listing associated with the extracted feature, and
display the product listing on the display based on the user size information,
wherein the processor, upon detecting that the computing device is operatively connected to a network having a printer, issues a paper coupon for the feature using the printer, and
wherein the processor, upon detecting that the computing device is not operatively connected to the network having the printer, issues an electronic coupon for the feature.

2.-4. (canceled)

5. The system according to claim 1, wherein:
the database is configured to store a matched extracted feature,
the server further comprises a discover module and an advertisement module,
the discover module, based on at least one of a location of the computing device, the matched extracted feature stored in the database. a browsing history, a purchase history, and the user size information, is configured to generate a recommended product listing, and
the advertisement module, based on at least one of the location of the computing device, the matched extracted feature stored in the database, the browsing history, the purchase history, and the user size information, displays a relevant advertisement on the display.

6. The system according to claim 1, wherein:
the database is configured to store a matched extracted feature,
the server further comprises a discover module, and
the discover module, based on at least one of the matched extracted feature stored in the database, the user size information, and a location of the computing device, is configured to generate a recommended product listing.

7. The system according to claim 1, wherein:
the database is configured to store a matched extracted feature,
the server further comprises an advertisement module, and
the advertisement module, based on the matched extracted feature stored in the database, is configured to display a relevant advertisement on the display.

8. The system according to claim 1, wherein the product listing comprises a uniform resource locator that is configured to redirect a user to a partner webpage associated with the product listing or a mobile deep link that is configured to redirect the user to a partner application associated with the product listing.

9. The system according to claim 1, wherein, if the extracted feature is a trademark, the display is configured to display a trademark product listing associated with the trademark.

10. The system according to claim 1 further comprising a second computing device that is configured to display a second product listing, wherein the server further comprises a discover module that is configured to display, on the display of the computing device, the second product listing.

11. The system according to claim 1, wherein:
the processor is further configured to compute a net worth of the image using the extracted feature, and
the display is configured to display the image showing the net worth.

12. A method comprising:
receiving, by a processor, an image from a computing device;
extracting. by the processor, a feature from the image;
determining, by the processor, a user size information for the feature using the image;
comparing, by the processor, an extracted feature to an entry in a database;
determining, by the processor, that the extracted feature matches the entry in the database;
receiving, by the computing device, a product listing associated with the extracted feature; and
displaying, by the computing device, the product listing on the computing device based on the user size information,
wherein the processor, upon detecting that the computing device is operatively connected to a network having a printer, issues a paper coupon for the feature using the printer, and
wherein the processor, upon detecting that the computing device is not operatively connected to the network having the printer, issues an electronic coupon for the feature.

13. (canceled)

14. The method according to claim 12, wherein:
the database is configured to store a matched extracted feature, and
the method further comprises displaying a recommended list based on at least one of a location of the computing device, the matched extracted feature, and the user size information.

15. The method according to claim 12 further comprising redirecting a user to a partner webpage associated with the product listing upon determining that the user has interacted with a link of the product listing.

16. (canceled)

17. The method according to claim 12 further comprising redirecting a user to a partner application associated with the product listing upon determining that the user has interacted with a link of the product listing and that the partner application is installed on the computing device.

18. The method according to claim 12, wherein, if the extracted feature is a trademark, the computing device is configured to display a trademark product listing associated with the trademark.

19. The method according to claim 12, further comprising displaying a second product listing displayed on a second computing device on the computing device.

20. A non-transitory computer readable medium comprising computer readable program code, which when executed by a computer processor, enables the computer processor to:
receive an image from a computing device;
extract a feature from the image;
determine a user size information for the feature based on the image;
compare an extracted feature to an entry in a database;
determine that the extracted feature matches the entry in the database;
store a matched extracted feature in the database;
receive a product listing associated with the extracted feature;
display the product listing on the computing device; and
redirect a user to a pal Her webpage associated with the product listing or to a partner application associated with the product listing upon determining that the user has interacted with a link of the product listing,
wherein the computer processor, upon detecting that the computing device is operatively connected to a network having a printer, issues a paper coupon for the feature using the printer, and
wherein the computer processor, upon detecting that the computing device is not operatively connected to the network having the printer, issues an electronic coupon for the feature.

21. The system according to claim 1, wherein:
the user size information is at least one selected from a group consisting of: a shoe size, an upper measurement, and a lower measurement,
the upper measurement is at least one selected from a group consisting of: sleeve length, sleeve width, shoulder length, chest length, waist size, and neck size, and
the lower measurement is an inseam measurement.

22. The system according to claim 1, wherein the displaying comprises arranging the product listing based on dynamic pricing that accounts for a user likelihood of purchase.

23. (canceled)

24. The system according to claim 1, wherein the partner server, upon determining that the computing device is operatively connected to a network having a printer and that a distance between the computing device and a vendor associated with the partner server carrying the feature is less than a predetermined distance, issues a paper coupon for the feature using the printer.

25. The system according to claim 5, wherein the recommended product listing is compiled based on user historical purchase data, the user historical purchase data including a timestamp of a user's previous purchase.
